(19) United States
(12) Patent Application Publication
(10) Pub. No.: US 2022/0395903 A1
(43) Pub. Date: Dec. 15, 2022

(54) PHOTO-THERMAL LASER PRINTING OF METALS AND METAL COMPOSITES IN 2D AND 3D

(71) Applicant: BAR-ILAN UNIVERSITY, Ramat Gan (IL)

(72) Inventors: Hagay SHPAISMAN, Kedumim (IL); Ehud GREENBERG, Givat Zeev (IL); Nina ARMON, Petach Tikva (IL)

(21) Appl. No.: 17/771,955

(22) PCT Filed: Oct. 27, 2020
(86) PCT No.: PCT/IL2020/051118

§ 371 Date: Apr. 26, 2022

Related U.S. Application Data
(60) Provisional application No. 62/927,707, filed on Oct. 30, 2019.

(51) Int. Cl. B22F 10/20; B33Y 10/00; B33Y 30/00; B41M 5/26

(52) U.S. Cl. CPC B22F 10/20; B33Y 10/00; B33Y 30/00; B41M 5/26

(57) ABSTRACT

A novel method for two-dimensional or three-dimensional photo-thermal printing of metals, oxides, alloys, and metal composites to produce objects having predetermined shapes is presented. The method comprises: providing a metal ion solution on a substrate; focusing modulated laser light with an objective lens system into the solution on the substrate, thereby causing a microbubble to form and attaching reduced metal ions to the substrate; and moving the focus of the modulated laser light in the x, y, and z directions to continuously form new microbubbles on the previously deposited structure and directly attach reduced metal ions to the previously deposited structure as metal, metal oxide, alloy, or metal composite until the predetermined shape of the object has been produced. The method can be carried out using both layer by layer printing and vector printing.

### FIELD OF THE INVENTION

The invention is from the field of additive manufacturing. Specifically, the invention is from the field of laser printing. More specifically the invention is from the field of laser printing of metals, metal oxides and metal composites.

### BACKGROUND OF THE INVENTION

Publications and other reference materials referred to herein are numerically referenced in the following text and respectively grouped in the appended Bibliography, which immediately precedes the claims.

While 2D and 3D printing of polymeric materials is prevalent, metals are indispensable for structural support, heat dissipation and electrical conductivity. Extensive research to allow additive manufacturing (AM) of metals has resulted in a range of techniques, the most established of them are selective laser melting (SLM) and electron beam melting (EBM). However, these methods are not suitable for the microscale regime because they are limited by the size of the metal particles used and heat dissipation to minimum line width of tens of microns.

Several attempts have been made in the last few years by commercial companies to develop metal printing technologies for the sub cubic millimeter range for micro-electronic applications. Some of these attempts utilize inkjet methods for doing so. To date, none of them have produced a product that can work in a production environment in the field and none of them are aiming at producing parts in the size range of several microns to several dozen microns; because their droplets are 10's of microns in diameter.

It is therefore a purpose of the present invention to provide a laser printing method capable of producing very fine (˜1 μm feature size) single metal or multiple metals structures.

It is another purpose of the present invention to provide a laser printing method capable of producing single metal, multiple metals, metal oxides or alloys structures having good and homogenous structure with very fine surface roughness.

It is another purpose of the present invention to provide a laser printing method for providing improved finished material properties by combining nano-diamonds, nano-carbon particles, and similar nanoparticles with single metal or multiple metals structures.

Further purposes and advantages of this invention will appear as the description proceeds.

### SUMMARY OF THE INVENTION

Presented in this application is a novel method for two-dimensional with controlled height and three-dimensional photo-thermal printing of metals, metal oxides, alloys, and metal composites to produce objects having predetermined shapes. The method comprises:
a) providing a system comprising a laser, a device for modulating the laser, a X-Y-Z microscope stage, and an objective lens system;
b) mounting a substrate on the microscope stage;
c) providing a metal ion solution on the substrate;
d) modulating the laser light with the modulation device;
e) directing modulated laser light through the objective lens system;
f) focusing the modulated laser light with the objective lens system into the solution on the substrate, thereby causing a microbubble to form and attaching reduced metal ions to the substrate;
g) continue moving the substrate on the microscope stage in the X-Y-Z directions while simultaneously directing modulated laser light through the objective lens system to continuously form new microbubbles on the previously deposited structure and directly attach reduced metal ions to the previously deposited structure as metal, metal oxide, alloy, or metal composite until the predetermined shape of the object has been produced.

In embodiments of the method the laser is modulated using one of: a mechanical shutter, an optical chopper, and a device for controlling power delivered to the laser.

In embodiments of the method the metal ion solution comprises ions of at least one metal from the following families: transition metals, Alkali metals, Alkaline earth metals, post-transition metals, metalloids and lanthanides. In embodiments of the method the metals can be: copper, iron, platinum, aluminum, gold, silicon, tin and silver.

In embodiments of the method the metal ion solution comprises an aprotic polar solvent that could prevent oxidation of the formed metal structures such as: alkyl carbonates, esters, cyclic ethers, lactones, aliphatic ethers, amides, nitriles and sulfoxides.

In embodiments of the method the metal ion solution is provided on the substrate and previously deposited structure by one of:
a) using a syringe to deposit the solution as droplets; or
b) immersing the substrate in a bath containing the solution.

In embodiments of the method, when the metal ion solution is provided by immersing the substrate in a bath containing the solution, the metal ion solution is added to the bath as the deposited metal structure grows in order to maintain the top of the printed object a threshold distance below a surface of the metal ion solution.

The method can be carried out using the following printing methods:
a) layer by layer printing; and
b) vector printing.

In embodiments of the method the substrate is not moved and the system comprises an optical system configured to move the focus of the modulated laser light in the X-Y-Z directions to continuously form new microbubbles on the previously deposited structure and directly attach reduced metal ions to the previously deposited structure as metal, metal oxide, alloy, or metal composite until the predetermined shape of the object has been produced.

In embodiments of the method nanoparticles are added to the metal ion solution and incorporated into the printed structure by being deposited together with the metal ions.

In embodiments of the method two or more metallic ions are present in the solution thus forming a structure composed of more than one metal, metal oxide and/or an alloy. In these embodiments the printed object can have a two-dimensional shape.

All the above and other characteristics and advantages of the invention will be further understood through the following illustrative and non-limitative description of embodiments thereof, with reference to the appended drawings.

### BRIEF DESCRIPTION OF THE DRAWINGS

FIG. 1 schematically shows the convection flow surrounding a vapor bubble formed using the prior art 2D laser-induced microbubble technique (LIMBT) for deposition of preformed nanomaterials;

FIG. 2 shows a line formed by deposition of preformed Ag nanoparticles using the LIMBT technique;

FIG. 3 shows a line formed by deposition of preformed Ag nanoparticles using the modulated-LIMBT technique;

FIG. 4a schematically shows an embodiment of a system configured to carry out 3D photo-thermal laser printing of metals, metal oxides and metal composites;

FIG. 4b symbolically illustrates the photo-thermal process;

FIG. 5a and FIG. 5b are SEM images of an example of preliminary results for 3D iron oxide printing obtained by the inventors;

FIG. 6 is a SEM image showing a portion of the surface of the smaller diameter “leg” in FIG. 5a;

FIG. 7a and FIG. 7b show Photo-thermal printing of copper without oxidation, from copper chloride with NMP as solvent on a FR4 substrate (7a) and on a glass substrate (7b);

FIG. 8a and FIG. 8b are SEM images that demonstrate 3D printing of a bridge and a spiral that show the potential of freely printing structures without support; and

FIG. 9a and FIG. 9b show images of a portion of a 3D printed gold structure containing incorporated nano-diamonds.

### DETAILED DESCRIPTION OF EMBODIMENTS OF THE INVENTION

The present invention uses inexpensive continuous wave (CW) lasers to promote directed thermal decomposition of metal ion solutions, leading to formation of 2D with controlled height and 3D metallic microstructures with a feature size of ˜1 micro-meter. The method allows incorporation of various nanoparticles (NPs) in the metallic microstructures, thus forming metal composites with superb mechanical, thermal and magnetic properties. Moreover, this method can be used for printing various metal combinations and fast vector printing that form more homogenous structures when compared to layer by layer printing. Because the materials used are solutions of metal ions, they are abundant, cheap and reusable. In embodiments of the invention, two or more metallic ions are present in the solution thus forming a structure composed of more than one metal and/or an alloy.

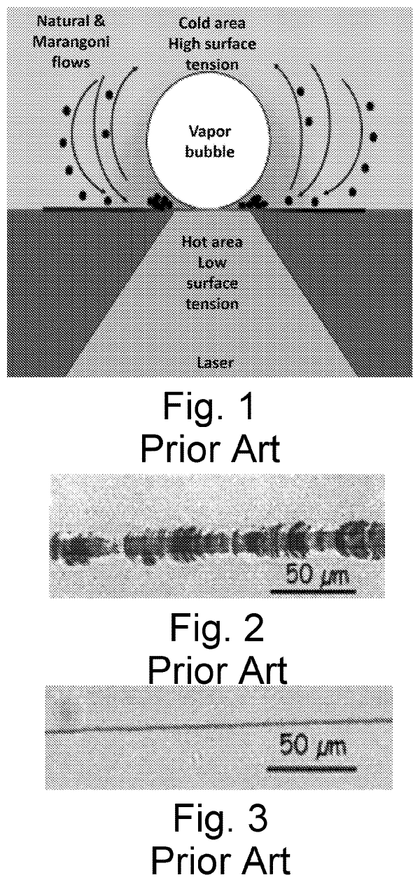

In the 2D laser-induced microbubble technique (LIMBT), a laser beam is focused on a dispersion of NPs. As the particles absorb the light and their temperature rises, vapor pressure from the surrounding medium increases until, eventually, a microbubble is formed. Then, two types of convective flow occur: natural and Gibbs-Marangoni convection. Natural convection is a result of a temperature gradient between the top and bottom of the microbubble. As the hotter medium has lower density, it flows upwards. The Gibbs-Marangoni convection results from a surface-tension gradient within the dispersion. As the bottom of the microbubble has a lower surface tension than its upper part, the dispersion flows to the upper part of the microbubble. To compensate for these convections that stream the dispersion upwards, there is also flow toward the bottom of the microbubble. If the focal point is near the substrate, particles carried by the dispersion will be pinned to the bubble/substrate contact area. FIG. 1 schematically shows the convection flow surrounding a vapor bubble formed using the prior art 2D laser-induced microbubble technique for deposition of preformed NPs.

If the focused beam is moved relative to the sample, migration of the microbubble and deposition of fresh material at the bubble/substrate contact area takes place. LIMBT has two main limitations: inconsistency in continuousness, and a minimum linewidth of ˜4 μm [Ref 2,3]. So far, continuous patterns have only been reported for soft oxometalates [Ref 3], while most studies show images that demonstrate non-continuous patterns [Ref 2] or do not address this issue.

FIG. 2 shows a line formed by deposition of Ag nanoparticles using the LIMBT technique. The reason for the discontinuity of the line formation is that the formed microbubble advances in a non-continuous manner. The advancing stage moves the laser's focal spot, but the microbubble fails to follow, as it is pinned by the materials that are being deposited onto the microbubble base. The microbubble, eventually, leaps forward to be centered near the focal spot, but this leap results in non-continuous material deposition.

The inventors of the present invention have previously found [Ref 1] that by modulating the laser beam (with mechanical or electrical means) to control the formation and destruction of the microbubble, continuous material deposition can be achieved from preformed nanoparticles. They have named this method modulated-LIMBT. FIG. 3 shows a line formed by deposition of Ag nanoparticles using the modulated-LIMBT technique.

In modulated-LIMBT, when the laser is turned on, the laser energy is transferred to the microbubble, resulting in the expansion of the microbubble [Ref 3] and material deposition [Ref 4,5]. Once the laser is turned off, the microbubble rapidly collapses [Ref 3]. The inventors hypothesize that if the microbubble totally collapses, once the laser is turned on again, a new microbubble is formed at a new location which is determined by the stage movement. Depending on the modulation parameters (higher frequencies and/or lower duty cycles), the microbubble may shrink rather than totally collapse. In this case, the microbubble edges are detached from the deposited material and, once the laser is turned on, the microbubble follows the focus of the laser due to the Marangoni convection flow [Ref 3]. Either way, the pinning of the microbubble is avoided and better control over its size is achieved. An extended quantitative analysis of the dependence between modulation frequency and duty cycle with width and height of material deposition has also been carried out [Ref 1]. Comparison of FIG. 3 with FIG. 2 shows that, in addition to the lack of discontinuities in the line, the modulated LIMBT method provides improvement in the minimal width (down to ˜1 μm) compared to the standard, non-modulated LIMBT.

In the present invention the inventors show that in a similar way 2D and 3D printing of metals, oxides and alloys can be achieved without using preformed nanoparticles. When a laser is focused on a metal ion solution near a substrate, photo-thermal decomposition may occur. The metal ions are reduced and can directly attach to a previously deposited metal structure or form nanoparticles (NPs). These NPs will then move with the convection flows around the microbubble (that is also formed due to the exerted heat) and be deposited by pinning to its base. It is noted that the convection flows of the microbubble also serve to flow additional metal ions, and thus contribute to forming a steady and controllable deposition. As discussed above for 2D formations from preformed nanoparticles, a key element for receiving continuous features with high resolution in 2D and 3D from an ion solution is laser modulation. Without laser modulation, deposition can be uncontrollable. One can 2D or 3D print only very small elements (a few micrometers\hat{ }3) very slowly without modulation, before large bubbles appear that rip the forming structure.

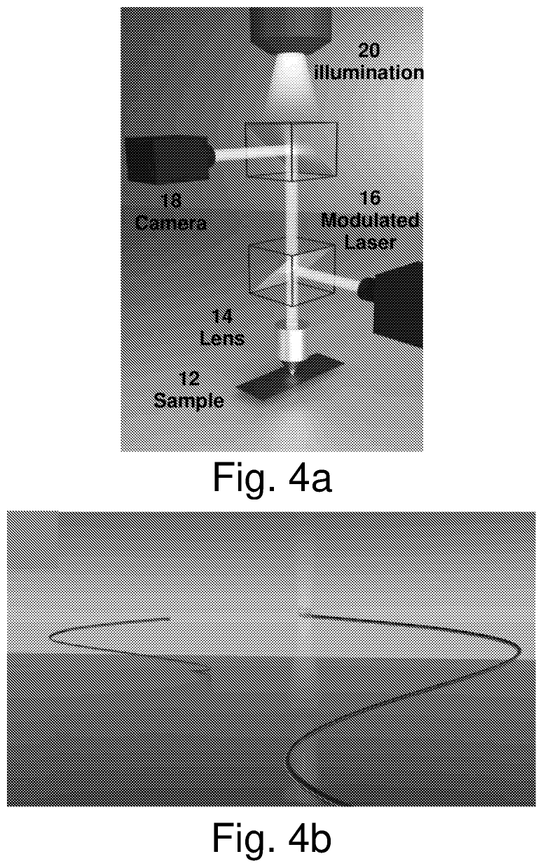

There are several configurations that could be used to carry out 2D and 3D photo-thermal laser printing of metals and metal composites, but for clarity and simplicity only the system schematically shown in FIG. 4a will be described herein.

The laser system 16 consists of a CW laser system attached to a microscope. Modulation of the CW laser is performed by mechanical means (mechanical shutter or an optical chopper) or electrical means (controlling the power delivered to the laser diode). The inventors have found that for the same parameters, all the types of modulation devices give similar results, but each instrument has a limited range of parameters. An objective lens system 14 (comprised of one or more lenses) focuses the laser light on the sample 12. In the work carried out various objective lenses (×10, ×20, ×40, ×50, ×60, ×100) have been employed. The microscope stage is computer-controlled and the experiments were recorded using a CMOS camera 18. The camera 18 and illumination source 20 are for research purposes only and can be omitted.

The metal ion solution can comprise ions of at least one any type of metal from the families: transition metals, Alkali metals, Alkaline earth metals, post-transition metals, metalloids and lanthanides.

The metal ion solutions can be deposited as droplets for printing small parts using a syringe (with surface tension holding them in place) or alternatively, the solution can be deposited in a bath with size varying according to the size of the required part. While using a bath for printing, solution droplets are added (by a syringe or tubes) whenever the printed object has reached below a threshold distance (that varies depending on solution concentration, ion type, laser intensity etc.) from the upper part of the solution. The structure being printed is always immersed in solution.

FIG. 4b symbolically illustrates the photo-thermal process. The metal ions are reduced and can directly attach to a previously deposited metal structure or form nanoparticles. The nanoparticles will then move with the convection flows around the microbubble and then be deposited by pinning to its base. If the focused beam is moved relative to the sample, arbitrary 2D and 3D structures are formed.

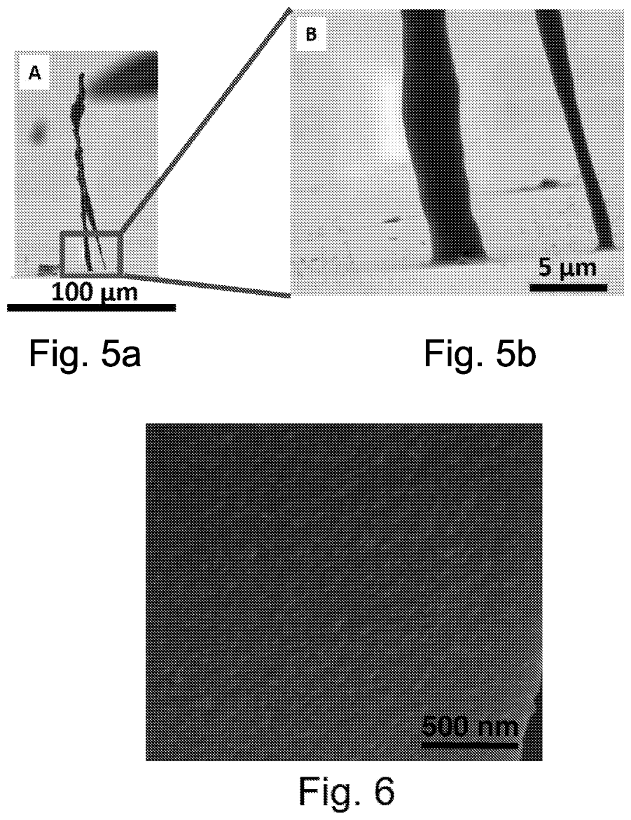

SEM images of an example of preliminary results for 3D iron oxide printing obtained by the inventors are presented in FIG. 5a and FIG. 5b. FIG. 5a shows the entire structure and FIG. 5b an enlargement of the lower part of the structure. To obtain these results a 2% wt iron(III)-acetylacetonate in diethylene glycol butyl ether (DB) metal ion solution, and a 10 mW, 532 nm laser that was modulated at 3 KHz with 50% duty cycle were used.

These preliminary results were obtained using manual control over X/Y/Z axes (using a joystick connected to the controller, hence the diversity in thickness). Nonetheless, it is impressive to see that long (the inventors didn't try more than ˜300 μm) freestanding columns are formed, standing on a base that is just ˜1 μm in diameter.

There are two general methods for 2D with controlled height and 3D printing: layer by layer (LBL) printing and vector printing. The LBL method is the most common method for 3D printing. It requires separating the 3D image into multiple 2D layers and then printing each layer sequentially. Vector printing is the direct printing of 2D with controlled height and 3D lines that together form the 2D with controlled height or 3D shape. Such a method that combines direct ink writing with a focused laser that locally anneals printed metallic features “on-the-fly” was recently developed by the group of Jennifer Lewis from Harvard [Ref 6]. 3D pens also use the same concept.

One of the unique abilities of the present photo-thermal method is that both LBL and vector printing can be used. The advantage of vector printing over LBL printing is that it is faster and can form hanging structures without support.

It is pointed out that both three-dimensional and two-dimensional shape can be produced by depositing only one layer. The modulation parameters (frequency and duty cycle) for a set of stage velocities and laser powers could be varied to allow additional control over deposition characteristics such as height, width, continuity and density.

It is also noteworthy to point out that the structures obtained in the preliminary results described in the preceding paragraphs were created by vector printing. Vector printing combined with metal sintering also leads to a very smooth outer-layer.

FIG. 6 is an SEM image showing a portion of the surface of the smaller diameter leg in FIG. 5a. This image shows that the method has the potential of reducing the surface roughness to less than 100 nm (in fact the surface roughness in this figure is on the order of tens of nanometers). This is achieved by continuously drawing the features (vector printing) and not by adding layers on layers. With vector printing the uniformity and adhesion between layers should also be improved compared to layer by layer printing. Theoretically the Z resolution can be as sensitive as 10 nm. In experiments performed to date the inventors have achieved sensitivity of 100 nm.

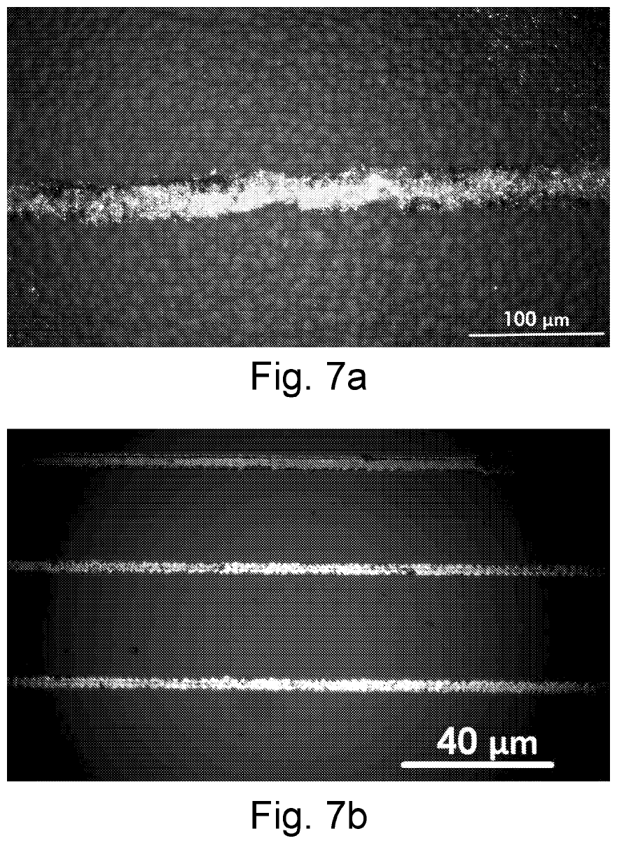

Most of the ion solutions, e.g. copper, iron, platinum, aluminum, and gold, used by the inventors to date are very stable and have not shown degradation even after a few months. The exception is solutions of silver (that are known for their instability), which when exposed to light shows degradation in the form of a deposit. The sensitive ions are stored covered to prevent exposure to light. FIG. 7a and FIG. 7b show images of photo-thermal printing of copper without oxidation, from copper chloride with NMP as solvent on a FR4 substrate (7a) and on a glass substrate (7b).

The preliminary results carried out by the inventors to date strongly indicate that the feature size (defined as the X & Y dimension upon a short laser illumination without moving the stage) is controllable by adjusting laser power, modulation parameters and the focusing objective and can vary from 1 μm to 500 μm (see for example the “legs” in FIG. 5b). This property can be taken advantage of by using large feature size for fast printing of relatively large objects, and small feature sizes when very delicate structures are needed.

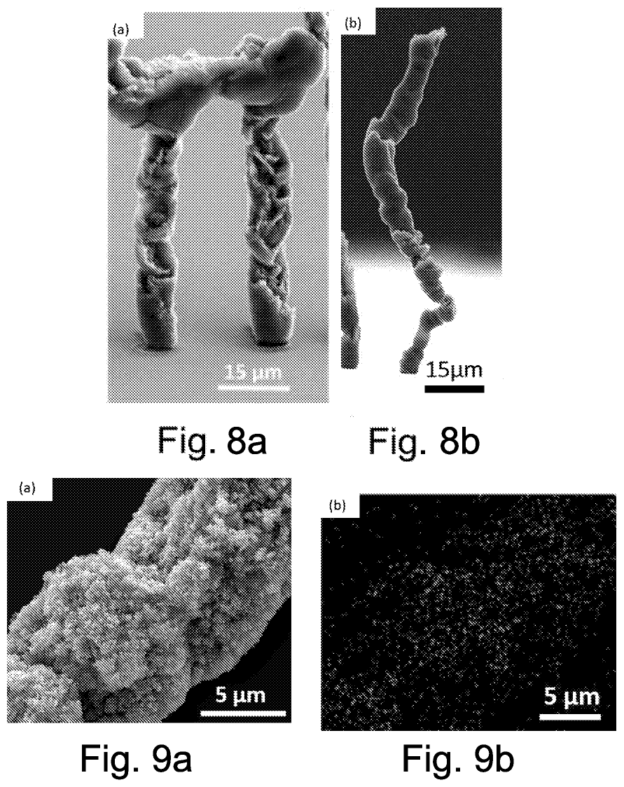

FIG. 8a and FIG. 8b are SEM images that demonstrate 3D printing of a bridge and a spiral that show the potential of freely printing structures without support using vector printing. A 2% wt iron(III)-acetylacetonate in diethylene glycol butyl ether (DB) metal ion solution was used, with a 10 mW, 532 nm laser that was modulated at 3 KHz with a 50% duty cycle.

Furthermore, advantage can be taken of the convection flows around the microbubble to incorporate nanoparticles that are added to the metal ion solution. Conceptually, any kind of nanoparticle could be added with controlled amounts by changing the ratio between the metal ions and nanoparticles. The nanoparticles could therefore be used to improve the properties of the metal. FIG. 9a and FIG. 9b show images of a portion of a 3D printed gold structure containing incorporated nano-diamonds. This also has never been previously achieved in 2D.

FIG. 9a is an SEM image of an Au structure (deposited from 10% wt chlorauric acid in DB) combined with 1% wt. 50 nm nano-diamond nanoparticles that were added to the solution. FIG. 9b is an energy-dispersive X-ray spectroscopy (EDS) analysis showing carbon attributed to the nano-diamonds.

It is important to distinguish between the photo-thermal (PT) method described herein and the previously reported laser-induced photo-reduction (PR) method [Ref 7,8] also known as two/multi photo reduction. While the laser-induced PR method has some common features with the present method, the PT method has several advantages since: The PR process requires expensive (>100K$) femto-second lasers to allow a multi-photon process, while the PT process can work with low intensity, continuous wave inexpensive lasers (potentially <10$).
PR usually requires additives (such as dyes) for the multi-photon process, while the
PT method does not require any additives.
PR is favorable for metal ions with large reduction potentials and may not work for iron, aluminum etc. The inventors have shown that the PT method works for these metals.
The PT process causes convection flows that can allow incorporation of NPs and nano-rods for metal composite formations. This is not possible with the PR process.
The PT process has a “built in” annealing step resulting in a smooth outer-layer. PR results in a rough surface finish and requires separate annealing.

A printer (3D and 2D) incorporating the photo-thermal method described herein could be used for the following applications:

Microelectronics:
1. Electrodes for micro-batteries.
2. Very fine encoder scales and read heads.
3. Locally fixing disconnection.
4. SEM gun tips emitting the electron beams.
5. Building very fine 3D conductors in semiconductor chips and arrays.
6. Building physical transducers like strain gages and weight cells.
7. Multilayered (conductive and insulating) structures.

Microelectromechanical systems (MEMS):
1. Micro-robots.
2. Micro accelerometers & micro gyroscopes.
3. Shielding, guiding or separating fluids in medical devices, reactors, heat exchangers, fuel cells and other microfluidic applications.

Medicinal devices:
1. Stents.
2. Minimize the size of heart pacers and extend the life expectancy of the batteries.
3. Under skin medicine dosage pumps.

Although embodiments of the invention have been described by way of illustration, it will be understood that the invention may be carried out with many variations, modifications, and adaptations, without exceeding the scope of the claims.

### BIBLIOGRAPHY

[1] N. Armon, E. Greenberg, M. Layani, Y. S. Rosen, S. Magdassi, H. Shpaisman, Continuous Nanoparticle Assembly by a Modulated Photo-Induced Microbubble for Fabrication of Micrometric Conductive Patterns, ACS Appl. Mater. Interfaces. 9 (2017) 44214-44221.
[2] Y. Zheng, H. Liu, Y. Wang, C. Zhu, S. Wang, J. Cao and S. Zhu, Lab. Chip, 2011, 11, 3816.
[3] B. Roy, M. Arya, P. Thomas, J. K. Jürgschat, K. Venkata Rao, A. Banerjee, C. Malla Reddy and S. Roy, Langmuir, 2013, 29, 14733-14742.
[4] Y. J. Zheng, Y. Wang, H. Liu, C. Zhu, S. M. Wang, J. X. Cao and S. N. Zhu, AIP Adv., 2012, 2, 022155.
[5] Y. Nishimura, K. Nishida, Y. Yamamoto, S. Ito, S. Tokonami and T. Iida, J. Phys. Chem. C, 2014, 118, 18799-18804.
[6] M. A. Skylar-Scott, S. Gunasekaran and J. A. Lewis, Proc. Natl. Acad. Sci., 2016, 113, 6137-6142.
[7] Tanaka, T., Ishikawa, A. & Kawata, S. Two-photon-induced reduction of metal ions for fabricating three-dimensional electrically conductive metallic microstructure. Appl. Phys. Lett. 88, 081107 (2006).
[8] Shoji Maruo and Tatsuya Saeki, Femtosecond laser direct writing of metallic microstructures by photoreduction of silver nitrate in a polymer matrix, Optics Express, Volume 16, Issue 2, Page 1174-1179 (2008).

1. A method for two-dimensional with controlled height and three-dimensional photo-thermal printing of metals, metal oxides, alloys, and metal composites to produce objects having predetermined shapes, the method comprising:
a) providing a system comprising a laser, a device for modulating the laser, a X-Y-Z microscope stage, and an objective lens system;
b) mounting a substrate on the microscope stage;
c) providing a metal ion solution on the substrate;
d) modulating the laser light with the modulation device;
e) directing modulated laser light through the objective lens system;
f) focusing the modulated laser light with the objective lens system into the solution on the substrate, thereby causing a microbubble to form and attaching reduced metal ions to the substrate;
g) continue moving the substrate on the microscope stage in the X-Y-Z directions while simultaneously directing modulated laser light through the objective lens system to continuously form new microbubbles on the previously deposited structure and directly attach reduced metal ions to the previously deposited structure as metal, metal oxide, alloy, or metal composite until the predetermined shape of the object has been produced.

2. The method of claim 1, wherein the laser is modulated using one of: a mechanical shutter, an optical chopper, and a device for controlling power delivered to the laser.

3. The method of claim 1 where the metal ion solution comprises an aprotic polar solvent such as: alkyl carbonates, esters, cyclic ethers, lactones, aliphatic ethers, amides, nitriles and sulfoxides.

4. The method of claim 1, wherein the metal ion solution comprises ions of at least one metal from the following families: transition metals, Alkali metals, Alkaline earth metals, post-transition metals, metalloids, and lanthanides.

5. The method of claim 4, wherein the metal ion solution comprises ions of at least one of the following metals: copper, iron, platinum, aluminum, gold, silicon, tin and silver.

6. The method of claim 1, wherein the metal ion solution is provided on the substrate and previously deposited structure by one of:
a) using a syringe to deposit the solution as droplets; or
b) immersing the substrate in a bath containing the solution.

7. The method of claim 6, wherein, when the metal ion solution is provided by immersing the substrate in a bath containing the solution, the metal ion solution is added to the bath as the deposited structure grows in order to maintain the top of the printed object a threshold distance below a surface of the metal ion solution.

8. The method of claim 1, wherein the method can be carried out using the following printing methods:
a) layer by layer printing; and
b) vector printing.

9. The method of claim 1, wherein the substrate is not moved and the system comprises an optical system configured to move the focus of the modulated laser light in the X-Y-Z directions to continuously form new microbubbles on the previously deposited structure and directly attach reduced metal ions to the previously deposited structure as metal, metal oxide, alloy, or metal composite until the predetermined shape of the object has been produced.

10. The method of claim 1, wherein nanoparticles are added to the metal ion solution and incorporated into the printed structure by being deposited together with the metal ions.

11. The method of claim 10, wherein the printed object has a two-dimensional shape.

12. The method of claim 1, wherein two or more metallic ions are present in the solution thus forming a structure composed of more than one metal and/or oxide and/or an alloy.

13. The method of claim 12, wherein the printed object has a two-dimensional shape.
